(19) United States
(12) Patent Application Publication
(10) Pub. No.: US 2021/0173532 A1
(43) Pub. Date: Jun. 10, 2021

(54) AUTOMOTIVE VEHICLE HAVING A FLEXIBLE MOBILE DEVICE MANAGER

(71) Applicants: Marc Van der Keere, Rochester Hills, MI (US); John D. Nulty, Brighton, MI (US); Elizabeth M. Beaubien, Lapeer, MI (US); Jorge Normand Rodriguez, Macomb, MI (US)

(72) Inventors: Marc Van der Keere, Rochester Hills, MI (US); John D. Nulty, Brighton, MI (US); Elizabeth M. Beaubien, Lapeer, MI (US); Jorge Normand Rodriguez, Macomb, MI (US)

(21) Appl. No.: 17/116,084

(22) Filed: Dec. 9, 2020

Related U.S. Application Data
(60) Provisional application No. 62/946,214, filed on Dec. 10, 2019.

(51) Int. Cl. G06F 3/0482; H04W 4/48; H04W 4/80; H04L 29/06; G06F 3/0488; H04W 76/10; G06F 3/0484

(52) U.S. Cl. CPC G06F 3/0482; H04W 4/48; H04W 4/80; H04W 84/12; G06F 3/0488; H04W 76/10; G06F 3/04847; H04L 65/60

(57) ABSTRACT

An infotainment system of a vehicle includes a touch display and a controller configured to output and control a single mobile device manager user interface (UI) on the touch display including (i) a list UI element listing mobile devices associated with the infotainment system including, for each mobile device of the list of mobile devices, at least a hands-free calling status UI element, a music streaming status UI element, a projection status UI element, (ii) a preferred mobile device UI element indicating two or more preferred mobile devices atop the list of mobile devices that will automatically connect to the infotainment system via a short-range wireless communication medium upon vehicle start-up, and (iii) a one-touch UI element that, when selected as a single touch input by a user via the touch display, controls which mobile devices of the list of mobile devices are preferred.

### CROSS-REFERENCE TO RELATED APPLICATION(S)

This application claims the benefit of United States Provisional Application No. 62/946,214, filed on Dec. 10, 2019. The disclosure of this application is incorporated herein by reference in its entirety.

### FIELD

The present application generally relates to vehicle infotainment systems and, more particularly, to vehicle infotainment systems and corresponding methods of user interface display and control to provide a flexible mobile device manager.

### BACKGROUND

Many automotive vehicles have a variety of interfaces for interfacing with mobile devices, such as cellular phones and tablets, and in a variety of ways. These interfaces include one or more of wireless and wired connectivity, such as WiFi wireless connectivity and Bluetooth wireless connectivity, hard wire connectivity such as universal serial bus (USB) ports, charging ports which in some cases are also USB ports, and the like. These interfaces are coupled to one or more systems in the vehicle that provide various types of functionality to the mobile device when it is coupled to the interface. One such system is an infotainment system that typically has a head unit having a touch screen display, an audio system and a radio. The infotainment system typically includes control logic, such as software, software for managing the mobile devices that are interfaced to the vehicle, which will be referred to herein as the “mobile device manager.” Currently, mobile device managers in vehicle assume a predefined function for each type of interface.

For example, when a mobile device is connected to a USB port the mobile device manager assumes that the mobile device's user wishes to stream media from the mobile device to the infotainment system and transfers the streaming function to the mobile device. However, it may be that the mobile device's user only wants to charge the mobile device. As more ports and other interfaces are added to vehicles and more mobile devices are brought into the vehicles by occupants of the vehicles, this present a problem in terms of which mobile device is assigned to and/or given control over which function. For example, if the vehicle has two USB ports with each having a mobile device plugged into it, current mobile device managers would assume that the user of each mobile device wishes to stream media to the infotainment system display resulting in a conflict. The users would then need to take action to resolve the conflict, such as by disconnecting one of the mobile devices from the USB port to which it is connected or turning the streaming function off for that USB port via the infotainment system. Accordingly, while such vehicle mobile device managers work well for their intended purpose, there remains a need for improvement in the relevant art.

### SUMMARY

According to one example aspect of the invention, an infotainment system of a vehicle is presented. In one exemplary implementation, the infotainment system comprises a touch display configured to display information to and receive touch input from a user of the vehicle and a controller in communication with the touch display to output and control a single mobile device manager user interface on the touch display, the single mobile device manager user interface including (i) a list user interface element listing mobile devices associated with the infotainment system including, for each mobile device of the list of mobile devices, at least a hands-free calling status user interface element, a music streaming status user interface element, a projection status user interface element, (ii) a preferred mobile device user interface element indicating two or more preferred mobile devices atop the list of mobile devices that will automatically connect to the infotainment system via a short-range wireless communication medium upon vehicle start-up, and (iii) a one-touch user interface element that, when selected as a single touch input by a user via the touch display, controls which mobile devices of the list of mobile devices are the two or more preferred mobile devices.

In some implementations, the single mobile device manager user interface does not require a user of the touch display to browse through sub-menus or alternate user interfaces to controls which mobile devices of the list of mobile devices are the two or more preferred mobile devices. In some implementations, the list user interface element further includes, for each mobile device of the list of mobile devices, a charging status user interface element indicating whether wired charging is enabled or disabled.

In some implementations, at least some mobile devices of the list mobile devices are set to a charging-only mode such that they are only allowed to perform wired charging. In some implementations, the single device manager user interface further comprises a device settings user interface element that, when selected for a particular mobile device of the list of mobile devices, causes the controller to temporarily display and control a separate, more detailed device settings user interface on the touch display.

In some implementations, the device settings user interface specifies more detailed connectivity settings for the particular mobile device, including a separate preferred mobile device user interface element, a separate hands-free calling status user interface element, a separate music streaming status user interface element, a separate projection status user interface element, and a separate wired charging status user interface element that are all controllable via touch inputs by the user to specify settings for the particular mobile device.

In some implementations, the short-range wireless communication medium is one of Bluetooth and WiFi Direct. In some implementations, the infotainment system only comprises two transceivers for communication with two mobile devices via the short-range wireless communication medium.

According to another example aspect of the invention, a method of providing and controlling a single mobile device manager user interface on a touch display of an infotainment system of a vehicle is presented. In one exemplary implementation, the method comprises providing the infotainment system comprising the touch display and a controller in communication with the touch display and outputting and controlling, by the controller, the single mobile device manager user interface on the touch display, the single mobile device manager user interface comprising (i) a list user interface element listing mobile devices associated with the infotainment system including, for each mobile device of the list of mobile devices, at least a hands-free calling status user interface element, a music streaming status user interface element, a projection status user interface element, (ii) a preferred mobile device user interface element indicating two or more preferred mobile devices atop the list of mobile devices that will automatically connect to the infotainment system via a short-range wireless communication medium upon vehicle start-up, and (iii) a one-touch user interface element that, when selected as a single touch input by a user via the touch display, controls which mobile devices of the list of mobile devices are the two or more preferred mobile devices.

In some implementations, the single mobile device manager user interface does not require a user of the touch display to browse through sub-menus or alternate user interfaces to controls which mobile devices of the list of mobile devices are the two or more preferred mobile devices. In some implementations, the list user interface element further includes, for each mobile device of the list of mobile devices, a charging status user interface element indicating whether wired charging is enabled or disabled.

In some implementations, at least some mobile devices of the list mobile devices are set to a charging-only mode such that they are only allowed to perform wired charging. In some implementations, the single device manager user interface further comprises a device settings user interface element that, when selected for a particular mobile device of the list of mobile devices, causes the controller to temporarily display and control a separate, more detailed device settings user interface on the touch display.

In some implementations, the device settings user interface specifies more detailed connectivity settings for the particular mobile device, including a separate preferred mobile device user interface element, a separate hands-free calling status user interface element, a separate music streaming status user interface element, a separate projection status user interface element, and a separate wired charging status user interface element that are all controllable via touch inputs by the user to specify settings for the particular mobile device.

In some implementations, the short-range wireless communication medium is one of Bluetooth and WiFi Direct. In some implementations, the infotainment system only comprises two transceivers for communication with two mobile devices via the short-range wireless communication medium.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 illustrates a functional block diagram of a vehicle comprising an example infotainment system according to the principles of the present application;

FIG. 2 illustrates an example single device manager user interface displayable on and controllable via a touch display of the infotainment system according to the principles of the present application;

FIG. 3 illustrates an example separate device settings user interface displayable on and controllable via the touch display of the infotainment system according to the principles of the present application; and

FIG. 4 is a flow diagram of an example method of providing and controlling a single mobile device manager user interface on a touch display of an infotainment system of a vehicle according to the principles of the present application.

### DESCRIPTION

As previously discussed, conventional vehicle device managers require substantial user involvement to specify device connectivity settings with the vehicle. This could include, for example, adjusting wired connections and/or browsing through a plurality of menus and sub-menus to specify the device connectivity settings. Accordingly, an improve vehicle infotainment system and a method of providing and controlling a single device manager user interface on a touch display of the infotainment system are presented.

This single device manager user interface allows for full viewing and control by the user via the touch display to control connectivity settings including two or more preferred mobile devices that automatically connect to the infotainment system via a short-range wireless communication medium upon vehicle start-up, as well as a one-click user interface element that, when selected as a single touch input by a user via the touch display, controls which mobile devices of a list of mobile devices are the two or more preferred mobile devices. One primary potential benefit of these systems and methods include is an overall improved user experience.

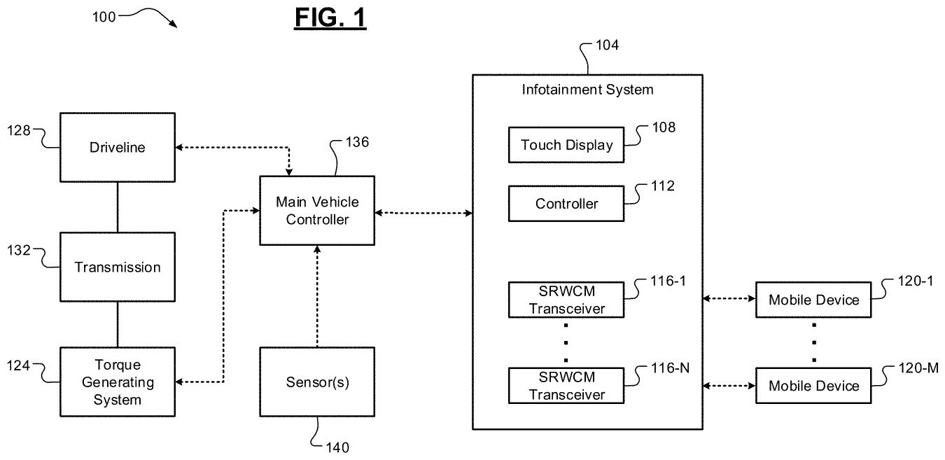

Referring now to FIG. 1, a functional block diagram of a vehicle 100 comprising an example infotainment system 104 having a touch display 108 and a controller 112 according to the principles of the present application is illustrated. The touch display 108 is configured to display information to and receive touch input from a user (driver, passenger, etc.) of the vehicle 100. The controller 112 is in communication with the touch display to output and control a single device manager user interface as described above and as more fully described below. The infotainment system 104 further comprises two or more short-range wireless communication medium (SRWCM) transceivers 116-1 . . . 116-N (N>1; collectively “SRWCM transceivers 116”). Each SRWCM transceiver 116 is configured to wirelessly communicate with one of a plurality of mobile devices 120-1 . . . 120-M (M>1, but M does not need to equal N; collectively, “mobile devices 120”) via one or more short-range wireless communication mediums.

Two examples of the short-range wireless communication mediums are Bluetooth and WiFi Direct, but it will be appreciated that other short-range wireless communications could be utilized such as, but not limited to, near field communication (NFC). In addition, while two SRWCM transceivers 116 are explicitly discussed herein, it will be appreciated that the infotainment system 104 could comprise three or more SRWCM transceivers 116 for simultaneous connection with three or more mobile devices 120. The vehicle 100 further comprises a torque generating system 124 that generates drive torque that is transferred to a driveline 128 via a transmission 132 for vehicle propulsion. Operation of the vehicle 100 (i.e., outside of the infotainment system 104) is handled by a main vehicle controller 136 (e.g., an engine control unit, or ECU) and is typically based on measurements from various vehicle sensors 140. For example only, the main vehicle controller 136 could control the torque generating system 124 to generate a desired amount of drive torque to meet a driver torque request as measured by one of the sensors 140.

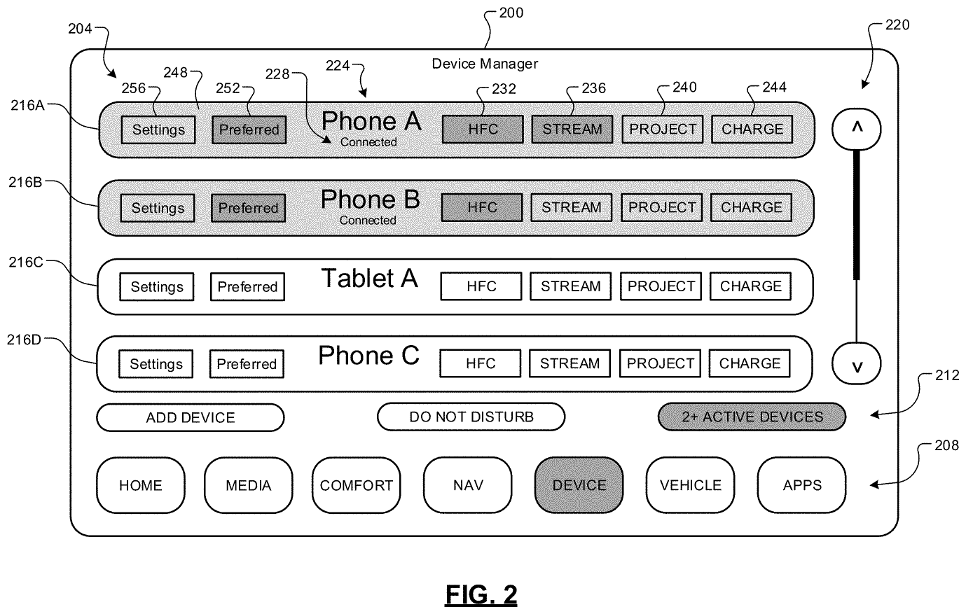

Referring now to FIG. 2, an example single mobile device manager user interface 200 (“Device Manager”) displayable on and controllable via the touch display 108 according to the principles of the present application is illustrated. The user interface 200 comprises a list user interface element 204 listing mobile devices 120 associated with the infotainment system 104. This could include, for example, mobile devices 120 currently or previously connected to the infotainment system 104. At a bottom portion of the user interface 200, a main horizontal navigation bar 208 includes selectable icons for various vehicle systems (Home, Media, Comfort, Navigation, Device, Vehicle, and Apps). As shown, the Device icon has been selected to bring up the user interface 200. Another horizontal sub-bar 212 includes selectable icons for adding new mobile devices, to enter a do not disturb mode, and an indicator or enable/disable icon for whether two or more mobile devices 120 can be simultaneously connected to the infotainment system 104. As shown, this indicator is highlighted indicating that two or more connections are capable. Lastly, a vertical navigation bar 220 allows for scrolling through the mobile devices 120 in the list user interface element 204.

For each mobile device 120 in the list user interface element 204, a device-specific user interface element 216A-216D (collectively, “device-specific user interface elements 216”) is provided. As shown, there are at least four mobile devices 120 associated with the infotainment system 104: Phone A, Phone B, Tablet A, and Phone C. In each device-specific user interface element 216, there is at least a device identifier 224 (e.g., “Phone A”), a connection status identifier 228 (e.g., “Connected”), a hands-free calling (HFC) status user interface element 232, a music streaming status user interface element 236, and a projection status user interface element 240. The term “projection” as used herein refers to device-specific software (Apple CarPlay, Android Auto, etc.) that projects the devices operating system to the infotainment system 104. It is worth noting that when a projection mode is enabled, some other features may not be available. In some implementations, a charging status user interface element 244 could also be provided relating to wired charging (e.g., via USB or other suitable charging cord means), such as in relation to a charging-only mode which will be described in greater detail below.

In each device-specific user interface element 216, there is also a preferred mobile device indicator 248 (e.g., highlighting of the larger box and/or the smaller “Preferred” box) indicating two or more preferred mobile devices 120 atop the list of mobile devices that will automatically connect to the infotainment system 104 via the short-range wireless communication medium(s) upon vehicle start-up (Phone A and Phone B). Further, there is also a one-touch user interface element 252 that, when selected as a single touch input by a user via the touch display 108, controls which mobile devices 120 of the list of mobile devices are the two or more preferred mobile devices. For example, selecting the one-touch user interface element 252 for Tablet A in 216C could make Table A one of the two preferred mobile devices, likely replacing Phone B (second in priority) or prompting the user to verify which of the mobile devices 120 will no longer be preferred. Thus, the single mobile device manager user interface 200 does not require a user of the touch display 108 to browse through sub-menus or alternate user interfaces to controls which mobile devices 120 of the list of mobile devices are the two or more preferred mobile devices.

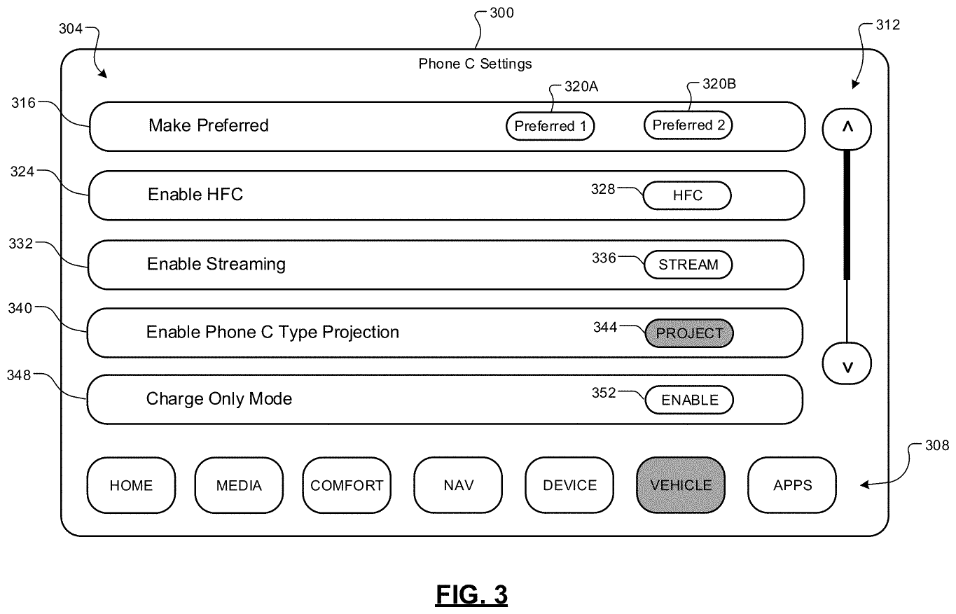

Referring now to FIG. 3 and with continued reference to FIG. 2, in some implementations, each device-specific user interface element 216 further includes a device settings user interface element 256 that, when selected for a particular mobile device of the list of mobile devices, causes the controller 112 to temporarily display and control a separate device settings user interface 300 on the touch display 108. As shown, this separate user interface 300 could be part of the vehicle settings and not the device manager as the “Vehicle” icon is highlighted in a main horizontal navigation bar 308. In the illustrated example, the device settings user interface element 256 for Phone C (not one of the preferred mobile devices) was selected (“Phone C Settings”).

While many or all of these settings are directly controllable via the single mobile device manager user interface 200, this user interface 300 provides more detail and more description about what each of the various settings means, and thus may be desirable for some users to specifically customize the connectivity settings for only a particular mobile device 120 at one time.

A settings list user interface element 304 includes a list of device-specific settings including a make preferred user interface element 316 comprising selectable preferred device icons 320A, 320B, an enable HFC user interface element 324 comprising a selectable HFC icon 328, an enable streaming user interface element 332 comprising a selectable streaming icon 336, an enable projection user interface element 340 comprising a selectable projection icon 344, and, in some implementations, a charge only mode user interface element 348 comprising a charge only mode enable icon 352. As shown, projection has been selected (see icon 344), so whenever Phone C becomes preferred and connects to the infotainment system, it will automatically enter the projection mode (unless overridden by a higher priority projecting device). These various user interface elements/icons are also described herein as separate elements/icons as they are part of user interface 300 and not user interface 200 and thus should not be confused with the elements/icons of user interface 200.

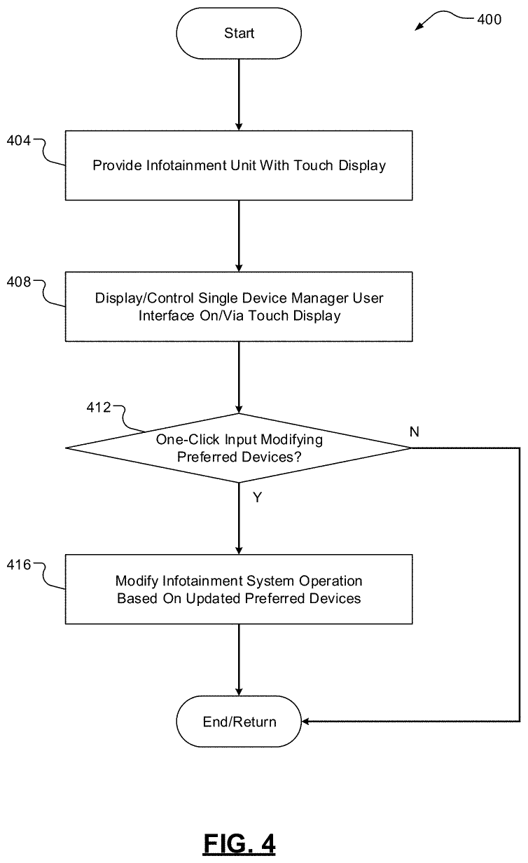

Referring now to FIG. 4, a flow diagram of an example method 400 for providing and controlling a single mobile device manager user interface on a touch display of an infotainment system of a vehicle is illustrated. For illustrative purposes, the components of vehicle 100 and its infotainment system 104 will be referenced, but it will be appreciated that the method 400 could be applicable to any suitable vehicle having an appropriate infotainment system. At 404, the infotainment system 104 comprising the touch display 108 are provided. At 408, the controller 112 of the infotainment system 104 displays and controls the single device manager user interface 200 on the touch display 108. At 412, the controller 112 determines whether a one-click input has been received via the single device manager user interface 200 to modify the preferred mobile devices. When false, the method 400 ends/returns or waits until such a one-click input has been received. When true, the method 400 proceeds to 416 where the controller 112 adjusts operation of the infotainment system 104 based on the updated preferred mobile devices. For example, when a previously disconnected mobile device 120 is made to be a preferred mobile device, its settings could override previously enabled settings for a previously-preferred mobile device 120 (e.g., switch from HFC and streaming to projection mode). The method 300 then ends or returns to 404/408 for another cycle.

It will be appreciated that the term “controller” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. An infotainment system of a vehicle, the infotainment system comprising:
a touch display configured to display information to and receive touch input from a user of the vehicle; and
a controller in communication with the touch display to output and control a single mobile device manager user interface on the touch display, the single mobile device manager user interface including:
(i) a list user interface element listing mobile devices associated with the infotainment system including, for each mobile device of the listing of mobile devices, at least a hands-free calling status user interface element, a music streaming status user interface element, and a projection status user interface element;
(ii) a preferred mobile device user interface element indicating two or more preferred mobile devices atop the list of mobile devices that will automatically connect to the infotainment system via a short-range wireless communication medium upon vehicle start-up; and
(iii) a one-touch user interface element that, when selected as a single touch input by a user via the touch display, controls which mobile devices of the listing of mobile devices are the two or more preferred mobile devices.

2. The infotainment system of claim 1, wherein the single mobile device manager user interface does not require a user of the touch display to browse through sub-menus or alternate user interfaces to controls which mobile devices of the list of mobile devices are the two or more preferred mobile devices.

3. The infotainment system of claim 1, wherein the list user interface element further includes, for each mobile device of the list of mobile devices, a charging status user interface element indicating whether wired charging is enabled or disabled.

4. The infotainment system of claim 3, wherein at least some mobile devices of the list mobile devices are set to a charging-only mode such that they are only allowed to perform wired charging.

5. The infotainment system of claim 4, wherein the single device manager user interface further comprises a device settings user interface element that, when selected for a particular mobile device of the list of mobile devices, causes the controller to temporarily display and control a separate, more detailed device settings user interface on the touch display.

6. The infotainment system of claim 5, wherein the device settings user interface specifies more detailed connectivity settings for the particular mobile device, including a separate preferred mobile device user interface element, a separate hands-free calling status user interface element, a separate music streaming status user interface element, a separate projection status user interface element, and a separate wired charging status user interface element that are all controllable via touch inputs by the user to specify settings for the particular mobile device.

7. The infotainment system of claim 1, wherein the short-range wireless communication medium is one of Bluetooth and WiFi Direct.

8. The infotainment system of claim 1, wherein the infotainment system only comprises two transceivers for communication with two mobile devices via the short-range wireless communication medium.

9. A method of providing and controlling a single mobile device manager user interface on a touch display of an infotainment system of a vehicle, the method comprising:
providing the infotainment system comprising the touch display and a controller in communication with the touch display; and
outputting and controlling, by the controller, the single mobile device manager user interface on the touch display, the single mobile device manager user interface comprising:
(i) a list user interface element listing mobile devices associated with the infotainment system including, for each mobile device of the list of mobile devices, at least a hands-free calling status user interface element, a music streaming status user interface element, a projection status user interface element;
(ii) a preferred mobile device user interface element indicating two or more preferred mobile devices atop the list of mobile devices that will automatically connect to the infotainment system via a short-range wireless communication medium upon vehicle start-up; and
(iii) a one-touch user interface element that, when selected as a single touch input by a user via the touch display, controls which mobile devices of the list of mobile devices are the two or more preferred mobile devices.

10. The method of claim 9, wherein the single mobile device manager user interface does not require a user of the touch display to browse through sub-menus or alternate user interfaces to controls which mobile devices of the list of mobile devices are the two or more preferred mobile devices.

11. The method of claim 9, wherein the list user interface element further includes, for each mobile device of the list of mobile devices, a charging status user interface element indicating whether wired charging is enabled or disabled.

12. The method of claim 11, wherein at least some mobile devices of the list mobile devices are set to a charging-only mode such that they are only allowed to perform wired charging.

13. The method of claim 12, wherein the single device manager user interface further comprises a device settings user interface element that, when selected for a particular mobile device of the list of mobile devices, causes the controller to temporarily display and control a separate, more detailed device settings user interface on the touch display.

14. The method of claim 13, wherein the device settings user interface specifies more detailed connectivity settings for the particular mobile device, including a separate preferred mobile device user interface element, a separate hands-free calling status user interface element, a separate music streaming status user interface element, a separate projection status user interface element, and a separate wired charging status user interface element that are all controllable via touch inputs by the user to specify settings for the particular mobile device.

15. The method of claim 9, wherein the short-range wireless communication medium is one of Bluetooth and WiFi Direct.

16. The method of claim 9 wherein the infotainment system only comprises two transceivers for communication with two mobile devices via the short-range wireless communication medium.
